(19) United States
(12) Patent Application Publication
(10) Pub. No.: US 2003/0019204 A1
(43) Pub. Date: Jan. 30, 2003

(54) Propulsion system

(75) Inventor: D. Clint Seward, Acton, MA (US)

Correspondence Address: THOMAS O. HOOVER, ESQ., BOWDITCH & DEWEY, LLP, 161 Worcester Road, P.O. Box 9320, Framingham, MA, 01701-9320, US

(73) Assignee: Electron Power Systems, Inc., Acton, MA (US)

(21) Appl. No.: 10/034,976

(22) Filed: Dec. 21, 2001

Related U.S. Application Data
(63) Continuation of application No. 09/129,147, filed on Aug. 5, 1998, now abandoned.
(60) Provisional application No. 60/055,013, filed on Aug. 7, 1997.

(51) Int. Cl. F03H 1/00

(52) U.S. Cl. 60/203.1

(57) ABSTRACT

The propulsion system of the present invention includes charged particles held in a containment structure at high temperatures. Propellant is injected into the containment system where it collides elastically with the charged particles. The propellant is heated until it achieves a high velocity. It can then be ejected to produce thrust. The propulsion system can include thrusters to propel, for example, space launch vehicles and jet aircraft.

### CROSS REFERENCES TO RELATED APPLICATIONS

The present application is a continuation co-pending U.S. patent application Ser. No. 09/129,147, filed Aug. 5, 1998, which is claims the benefit of U.S. application Ser. No. 60/055,013, filed Aug. 7, 1997.

The entire contents of the above applications are incorporated herein by reference in entirety.

### BACKGROUND OF THE INVENTION

There is a need to dramatically reduce the amount of propellant in rockets and space vehicles. A typical launch vehicle has a payload of approximately one percent of launch weight, the remainder being mainly fuel and fuel containment. This limits the capabilities of launch vehicles and makes launches from earth very expensive.

Space craft have an additional problem in that for long missions, they need to carry all of their propellant with them. This requirement causes their mass to be large, and limits their mission since refueling is impossible.

Most rockets and space craft today are propelled in the same way. They heat up the propellant, causing it to attain a high velocity, then eject it to create thrust in the direction of travel. Most of these vehicles use chemical reactions (combustion) to burn the rocket fuel and create a high heat environment. Fuel is typically heated in the range of 2200 to 4000° C. If the propellant could be heated well above this range, then the propellant would be raised to a significantly higher velocity, creating a commensurate increase in thrust, and reducing the amount of propellant required.

The same problems are associated with jet aircraft. The jet engine uses much fuel during a mission, and normally carries all fuel for the duration of the mission. While refueling is possible, it is not practical outside of some military missions.

What is needed is an alternative to chemical combustion as a source of rocket, space craft, and jet engine propulsion. A safe and non-radioactive fuel system is needed, preferably including a means to heat propellant above the range presently used. This would reduce the amount of propellant needed for a launch or for a space mission. This would also reduce the weight and increase the range of jet aircraft.

### SUMMARY OF THE INVENTION

The present invention provides a class of rockets and jets which use no chemical reactions or combustion to produce thrust. The energy source is the charged particle storage device (CPSD) which has been described in U.S. Pat. Nos. 5,175,466 and 5,589,727 and in U.S. application designated by International Application No. PCT/US96/08175, now U.S. Ser. No. 08/973,138 deposited on Dec. 1, 1997, the entire contents of the above patents and applications being incorporated herein by reference. The CPSD consists of a toroid of charged particles all of which have the same charge. The initiation of the CPSD is described in the referenced patents. The energy is stored mainly in the internal magnetic field of the CPSD.

A CPSD initiated in such manner can be charged with energy to a high total energy level. As such, it can be considered to be a hot entity, with electrons raised to a high total energy, for example, 10,000 electron volts or more. Electrons at this energy level are at the equivalent of 116,000,000° C. If a propellant is brought in close contact to the CPSD, it will be vaporized and will attain a high energy level through collisions with the CPSD. The propellant can thus be potentially raised to 29,000 times higher than the 4000° C. limits for chemical combustion. This translates into potentially 29,000 times less propellant required to achieve the same total thrust energy.

This invention provides a new class of thrusters for use in rockets, space craft, missiles, and aircraft. The use of the CPSD to energize propellants is detailed. In addition, the containment for the super heated propellant is provided.

### BRIEF DESCRIPTION OF THE DRAWINGS

FIGS. 1A and 1B show side and top views of a charged particle storage device.

FIG. 2 shows a CPSD thruster with neutral propellant injection.

FIG. 3 shows a CPSD thruster with ionized propellant injection.

FIG. 4 shows a CPSD aircraft thruster.

### DETAILED DESCRIPTION OF THE PREFERRED EMBODIMENT

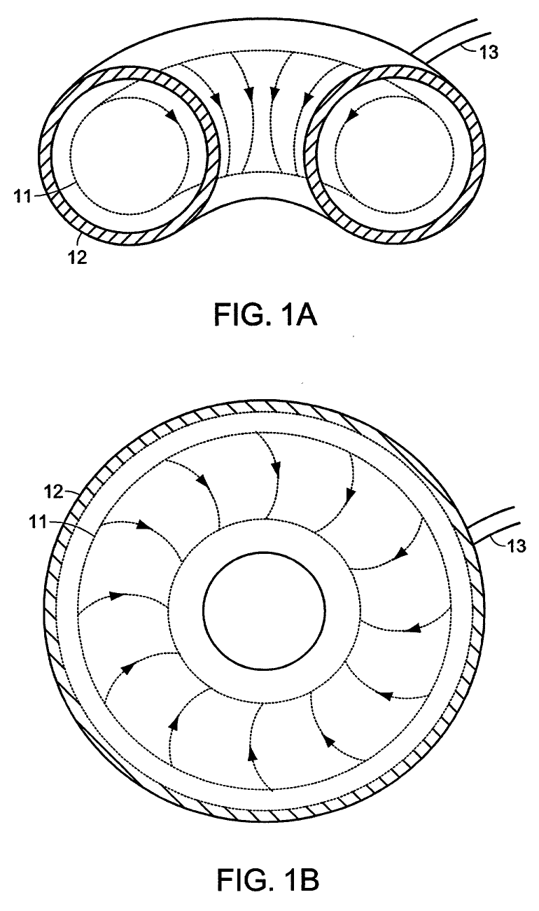

FIGS. 1A and 1B illustrate a CPSD containment system. FIG. 1A shows the CPSD in a cutaway view. FIG. 1B shows the CPSD and its containment in a top view. As described in the referenced patents and applications, the CPSD can be any charged particle spiral toroid. For the remainder of this patent, electrons are the charged particles considered, and so an electron spiral toroid will be described; however, other charged particles can be used.

In FIG. 1A, item 11 is a preferred embodiment of a charged electron orbit. Note the electrons form a hollow toroid, with the electrons orbiting in a thin outer layer. Surrounding the device is a containment system 12. The containment system is chosen to hold a total charge to counter the space charge of the electrons of the CPSD. It is also chosen to reflect any electromagnetic (particularly microwave) radiation which can be emitted from the rotating electrons. This is explained in detail in the referenced patents. The containment can typically be metal, with a charge retaining dielectric material. The containment of the CPSD requires a vacuum environment, provided via a vacuum port 13. While one vacuum port is shown, there can normally be several. The CPSD can be recharged as described in the referenced patents so that energy may be replenished.

The CPSD stores energy as magnetic field energy in its central magnetic field. The electrons can be stored in this CPSD at very high energy levels. However, if the electron velocity is too high, synchrotron radiation will become great enough that loss of energy is too great. The electron energy can be limited to 10,000 electron volts, a value above which the electrons are relativistic, and therefore below which synchrotron radiation can be compensated for in the design. An electron volt is 11,600° C., so 10,000 electron volts is 116,000,000° C. The CPSD can thus be considered as confining a hot medium being held in containment. As described below, if a propellant is brought into the CPSD containment, the propellant is heated.

High specific energy is achieved since energy is stored as electron kinetic energy and magnetic field energy. An electron volt is 1.602×10⁻¹⁹ joules (J), and electron mass is 9.11×10⁻³¹ kilograms (kg), giving 1.76×10¹¹ J/kg per electron volt. Electrons with 10,000 volts will have 1.76×10¹⁵ J/kg. The specific energy is really better than this, since most of the energy is contained in the internal magnetic field which has no mass. The magnetic field is calculated to contain approximately 99% of the energy, increasing the effective specific energy of the electrons to 1.76×10¹⁷ J/kg. This compares to liquid hydrogen with a specific energy of 1.2×.10⁸ J/kg. A million kg of liquid hydrogen can theoretically be replaced with a gram of charged particle mass.

Electrons have low mass, and, since there is little required to hold the electrons in orbit other than an electric field and a vacuum enclosure, the total energy load will have high specific energy. For complete comparison, the full CPSD system must be considered. Calculations show the CPSD containment weighs approximately 1 kg per 100 megajoules.

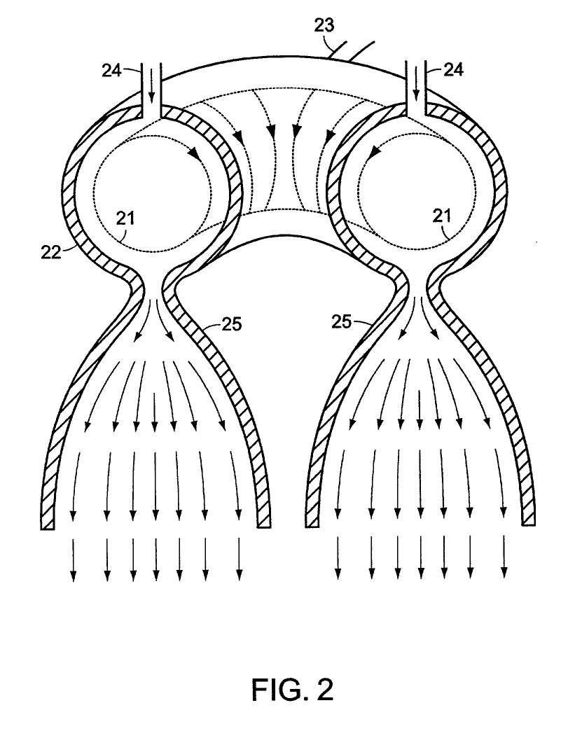

FIG. 2 is a diagram of a CPSD thruster. The toroidal system is shown as 21. The containment is 22, and a typical vacuum port is 23. A propellant injector port is shown as 24. Propellant is injected through this port into the chamber. The propellant can be solid or gas, depending on the design and the performance requirements. The propellant is typically injected under pressure. Once the propellant is in the containment chamber, it collides with the electrons and gain energy. As the propellant gains energy, it heats up and gains velocity. As the pressure in the chamber increases, the propellant is ejected out the exhaust port, 25, producing thrust.

This method of heating the propellant does not require combustion, so it does not need special rocket fuel or liquid hydrogen to propel the thruster. In this simple configuration, it heats the propellant to an amount controlled by the flow of the propellant past the electrons. The thrust can be controlled by moderating the flow of injected propellant into the chamber; as more propellant is injected, more propellant is ejected, producing more thrust. The thrust can be shut down completely, and restarted as needed by interrupting the flow of injected fuel, a distinct advantage over solid fuel rockets. The propellant can be air when the thruster is being used in atmosphere, a potentially important property for launch vehicles. The shape of the exhaust port can use existing nozzle design.

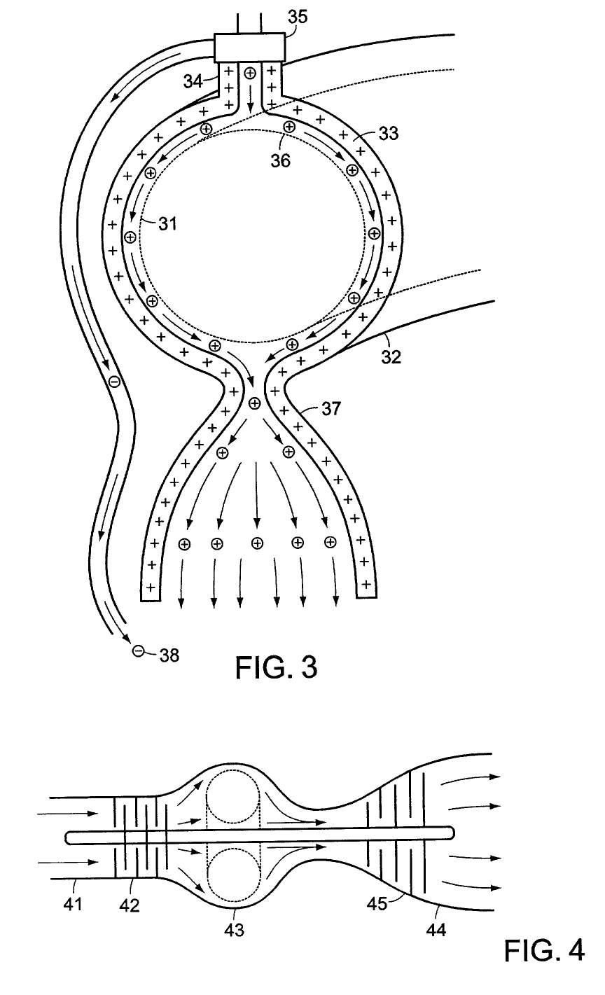

FIG. 3 is a diagram of a high temperature CPSD thruster which makes use of the unique properties of the CPSD. In this configuration, a toroidal system 31 is initiated and contained in a containment housing 32. For clarity, the details of the containment are not shown but are similar to FIG. 1 and FIG. 2. In this embodiment particular use is made of the fact that the containment holds a positive charge. This positive charge acts to hold the electrons in place. The spiral of electrons can actually have a slightly net positive in charge due to the ions trapped inside during initiation. The ions are slightly greater in number than the number of electrons This containing charge of the containment is shown as 33. The propellant is brought near the injection port 34 while still neutral in charge. Just prior to injection, it is ionized in a propellant ionizer 35. A typical ionizing technique is to move a gas propellant through a voltage screen. At the ionizer, the propellant is separated from its electrons. The ionized propellant 36 is then injected into the chamber. The propellant is heated by collisions with the electron surface. As the ions heat up, they move faster and faster since their velocity increases as their energy increases. The ions collide with the electrons, but the ions do not recombine with the electrons since the electrons are moving too fast. Similarly, the ions try to collide with the walls of the containment, but are repelled by the positive charge. With proper design, the ions move around the toroid as they are being heated, and are unable to penetrate the electron toroid or the containment walls before they are ejected out the thruster port 37. At this point, care must be taken to avoid building up a large positive charge at the exhaust due to the expulsion of positively charged propellant ions. This is done by injecting into the exhaust stream the electrons 38 which are produced in the ionizer. The electrons and ions are of opposite charge, so they will attract and recombine. The advantage of the ionized propellant thruster is that the propellant can be raised to much higher temperatures than can be done with combustion, but since the ionized propellant is confined by electrostatic fields, the problems of finding materials to withstand superheated propellant are avoided. Another advantage is that a variety of materials can be used as a propellant, whether gas or solid, since it is only being heated, not combusted.

FIG. 4 shows a CPSD thruster in use for aircraft where a steady supply of air is available which can be used as a propellant. The thruster is similar to a jet engine, except that no combustion is required, so no fuel is required on board, greatly reducing the weight of the aircraft. The air is brought in through the air inlet 41. For clarity, air flow direction is shown with arrows. The air is compressed with a compressor section 42. The compressed air flows past the toroid 43, colliding with it elastically, and being heated. The hot air is exhausted out the nozzle 44. As the air exits, it turns blades 45 which are used to power the compressor section.

This CPSD thruster can be used in aircraft wherever jet engines are used. The advantage is that there will be no fuel on board the aircraft and no propellant at all since air can be ingested and heated. A typical fighter aircraft carries 30,000 pounds of fuel, which is approximately 45% of the takeoff weight. Without the fuel, the aircraft can be smaller, lighter, and have far better performance. The containment for the electrons is less weight than the present fuel tanks on an aircraft.

The CPSD thruster can be used in water and underwater craft as well. Since no combustion is required, water can be brought in, heated, and ejected. This is particularly attractive for underwater devices, since no combustion is required which removes the necessity for carrying an oxidizer and fuel. It is also attractive since it is non-radioactive.

Equivalents

The preceding description is particular to the preferred embodiments and may be changed and modified without substantially changing the nature of the invention. While the invention has been particularly shown and described with reference to preferred embodiments thereof, it will be understood by those skilled in the art that various changes in form and details may be made therein without departing from the spirit and scope of the invention as defined by the appended claims.

What is claimed:

1. A propulsion system comprising:
a toroidally shaped charged particle containment system;
a propellant injection port;
a propellant ionizer; and
an exhaust port.

2. The system of claim 1 wherein the injection port comprises a gas injection port.

3. The system of claim 1 further comprising a plurality of electrons stored in the containment system.

4. The system of claim 3 wherein the containment system is positively charged.

5. The system of claim 1 wherein the containment system comprises a chamber having the injection port on one side and the exhaust port on an opposite side.

6. The system of claim 1 wherein the propellant comprises air.

7. The system of claim 1 wherein the propellant comprises a fluid.

8. A propulsion comprising:
a cylindrical electron containment system, the system containing a
plurality of electrons circulating in a toroidal shape;
a propellant injection port on the system; and
an exhaust port on the system.

9. The system of claim 8 wherein the containment system comprises a toroidally shaped housing.

10. The system of claim 8 further comprising a plurality of electrons stored in the containment system.

11. The system of claim 10 wherein the containment system is positively charged.

12. The system of claim 10 wherein the containment system comprises a chamber having the injection port on one side and the exhaust port on an opposite side.

13. The system of claim 10 wherein the propellant comprises air.

14. The system of claim 10 wherein the propellant comprises a fluid.

15. A propulsion system comprising:
an electron containment system housing;
an air inlet port on the housing;
a plurality of electrons in the housing that heat air flowing through the housing; and
an exhaust port on the housing.

16. The system of claim 15 wherein the containment system housing comprises a toroidally shaped housing.

17. The system of claim 15 wherein the containment system housing is positively charged.

18. The system of claim 15 wherein the containment system housing comprises a chamber having the injection port on one side and the exhaust port on an opposite side.

19. The system of claim 15 further comprising a magnetic field within the housing that contains the electrons.

20. The system of claim 15 wherein the housing comprises a dielectric material.
